(19) United States
(12) Patent Application Publication
(10) Pub. No.: US 2025/0189861 A1
(43) Pub. Date: Jun. 12, 2025

(54) OPTICAL MODULATOR

(71) Applicant: Enosemi, Inc., Sacramento, CA (US)

(72) Inventors: Matthew STRESHINSKY, Sacramento, CA (US); Ari NOVACK, Sacramento, CA (US); Meisam BAHADORI, Sacramento, CA (US)

(21) Appl. No.: 18/814,741

(22) Filed: Aug. 26, 2024

Related U.S. Application Data
(60) Provisional application No. 63/608,231, filed on Dec. 9, 2023.

(51) Int. Cl. G02F 1/225; G02F 1/21

(52) U.S. Cl. CPC G02F 1/2255; G02F 1/212

(57) ABSTRACT

An optical modulator includes two optical waveguide arms, each including a plurality of phase modulators. The phase modulators in each waveguide arm are electrically coupled to a single transmission line or between a pair of single-ended transmission lines to be differentially driven when the transmission line pair is connected to a differential driver. Inductors are positioned in each of the transmission lines to increase the overall impedance of the modulator to match an impedance of other electro-optical devices in a circuit. Electrical and optical signal velocity matching is provided by waveguide delay lines.

### TECHNICAL FIELD

The present invention generally relates to optical modulators, and in particular to a broad-band Mach-Zehnder optical waveguide modulator configured for impedance matching with other electro-optic devices while maintaining velocity matching between electrical and optical signals.

### BACKGROUND

Broad-band optical communications typically require high-speed electro-optical modulators (EOM) to modulate light at a desired data rate. One common type of a broad-band EOM is a Mach-Zehnder modulator (MZM) that uses a waveguide Mach-Zehnder (MZ) interferometric structure with RF-driven optical phase modulators in each arm. The waveguide arms of the MZM are typically formed in an electro-optic material, for example a suitable semiconductor or electro-optic dielectric material such as LiNbO₃, in which optical properties of the waveguide may be controlled by applying a voltage to the optical phase modulators. Such a waveguide modulator may be implemented in an opto-electronic chip as a photonic integrated circuit (PIC). A silicon photonics (SiP) platform based on Silicon on Insulator (SOI) technology, enables a natural integration with CMOS-based high-speed electronic drivers, may be particularly attractive for implementing broad-band modulators.

One common technique to high-speed modulation of propagating light, in particular at modulation rates on the order of 10-20 Gigabit per second (Gb/s) and higher, is the travelling wave approach, when the modulating electrical RF signals are applied to properly terminated electrical transmission lines that are electro-optically coupled and velocity-matched to the optical waveguides of the EOM. FIG. 1 schematically illustrates an example broad-band EOM in the form of a MZM 10 with two optical waveguide arms 11, 12 coupled to two electrical differential transmission lines 30 of length L, each formed by an inner signal electrode 22 and an outer signal electrode 21, with corresponding ground electrodes (not shown) and a differential transmission line termination 25. In the SiP platform, the outer and inner signal electrodes 21, 22 may be overlaying phase shifters 31, e.g. p/n junctions, formed across the optical waveguide arms 11 and 12 that may either inject carriers (forward bias) or deplete carriers (reverse bias) in the waveguide core to modulate the refractive index of the optical waveguide arms 11 and 12 by means of the carrier plasma dispersion effect. One known approach is a dual-differential modulation, in which each differential transmission line (TL) of the pair 30 is driven with a differential RF signal, so that in each inner electrode 22 and outer electrode 21 are driven with complementary single-ended RF signals, and the phase shifter 31 in the waveguide arms 11, 12 are modulated in counter-phase, which effectively doubles the phase modulation amplitude at the output optical combiner 32 of the MZM 10 for a given peak-to-peak (PP) drive voltage Vpp applied to each outer and inner electrode 21 and 22, as compared to more traditional implementations in which the inner electrodes 22 are grounded. The TL pairs 30 are configured so that the differential RF signals propagate along them at the same velocity as the light that is travelling in the waveguide arms 11, 12. However the dual differential MZM 10 of the type illustrated in FIG. 1 may require two differential drivers, or a single differential driver of a double output power, to drive the two TL pairs 30, which complicates the design. Additionally, further lessening the MZM driver power requirements is desirable in many applications.

The principal metrics that optical modulators are optimized against are typically VI, insertion loss, electrooptic bandwidth, impedance, optical bandwidth, size, and linearity. Notation Vπ refers to a bias voltage of a Mach-Zehnder modulator (MZM) that corresponds to a change in a relative phase delay between arms of the MZM by π radian (rad), or 180°, which corresponds to a change from a minimum to a next maximum in the MZM transmission versus voltage. One of the fundamental trade-offs in optical modulator design is Vπ and insertion loss. Longer optical phase shifters are required to increase the interaction length between the phase shifting material and light, but in doing so causes excess optical insertion loss through the phase shifters. It is desirable to enhance the Vπ of the modulator without adding excess insertion loss.

Accordingly, it may be understood that there may be significant problems and shortcomings associated with current solutions and technologies for providing high-bandwidth optical waveguide modulators.

### SUMMARY

The present disclosure relates to an optical waveguide modulator comprising two waveguide arms and one or two single-ended transmission lines, wherein each of the waveguide arms is electrically coupled to the single-ended transmission lines so as to be modulated when modulation signals are transmitted by the transmission lines.

An exemplary embodiment includes an optical modulator comprising:
an input optical port for receiving an input light signal;
an output optical port for outputting a modulated light signal;

first and second waveguide arms extending optically in parallel between the input and output optical ports to guide the input light signal from the input optical port to the output optical port along two light paths;

a first plurality phase shifters in the first waveguide arm;

a second plurality of phase shifters in the second waveguide arm;

a first transmission line (TL) extending along the first waveguide arm configured for transmitting an RF electrical signal to the first and/or second plurality of phase shifters for modulating the input optical signal and; and

a first inductor in the first transmission line configured for increasing impedance of the optical modulator.

According to any of the aforementioned embodiments the first inductor may comprise a plurality of first inductors spaced along the first transmission line; and wherein the second inductor comprises a plurality of second inductors spaced along the second transmission line.

According to any of the aforementioned embodiments the plurality of first inductors may be equally spaced along the first transmission line.

According to any of the aforementioned embodiments the plurality of first inductors may each have a same inductance value.

According to any of the aforementioned embodiments some of the plurality of first inductors may have different inductance values.

According to any of the aforementioned embodiments at least one of the plurality of first inductors may be positioned between adjacent electrical leads extending to adjacent ones of the first plurality of phase shifters.

According to any of the aforementioned embodiments the plurality of first inductors may be spaced non-uniformly along the first transmission line, but monotonically decreasing or increasing frequency in order to monotonically adjust the transmission line characteristic impedance.

According to any of the aforementioned embodiments the plurality of first inductors may have different inductance values.

According to any of the aforementioned embodiments each of the plurality of first inductors may have a value of a 50 pH to 5000 pH.

According to any of the aforementioned embodiments each of the plurality of first inductors may have a value of a 100 pH to 500 pH.

According to any of the aforementioned embodiments at least some of the plurality of first inductors may comprise an active inductor configured for adjusting the inductance value thereof during installation or use.

According to any of the aforementioned embodiments the first optical waveguide arm may include a first optical delay line that extends both in parallel and perpendicular to the first optical waveguide arm configured for matching velocity of the input optical signal and the RF electrical signal to compensate for delays caused by the first inductor.

According to any of the aforementioned embodiments at least one of the first plurality of phase shifters may be in the first optical delay line.

According to any of the aforementioned embodiments the first plurality of phase shifters may each comprise a plurality of series-connected phase shifter sections.

According to any of the aforementioned embodiments the first optical delay line may include a plurality of elongated sections extending parallel to the first transmission line, and a plurality of curved sections extending substantially perpendicular to the first transmission line

According to any of the aforementioned embodiments the first plurality of phase shifters may each comprise a plurality of parallel-connected phase shifter sections, in different sections of the plurality of elongated sections of the first optical delay line.

According to any of the aforementioned embodiments the modulator may further comprise a termination resistor in the first transmission line with a resistance configured for providing velocity matching between the RF electrical signal and the input optical signal to compensate for delays caused by the first inductor.

According to any of the aforementioned embodiments each of the plurality of first phase shifters may comprising a first anode electrode and a first cathode electrode; each of the plurality of second phase shifters may comprise a second anode electrode and a second cathode electrode

wherein the first transmission line may be electrically coupled to the first anode electrode of each of the first plurality of phase shifters, and to the second cathode electrode of each of the second plurality of phase shifters.

The modulator may further comprise:

a second transmission line (TL) extending along the second waveguide arm and electrically coupled to the first cathode electrode of each of the first plurality of phase shifters and to the second anode electrode of each of the second phase shifters; and

a second inductor in the second transmission line; and

a differential driver configured to feed complementary electrical signals into the first and second transmission lines.

According to any of the aforementioned embodiments the modulator may further comprise:

electrical circuitry configured for providing a DC bias voltage to the first cathode electrodes or the first anode electrodes of each of the first plurality of phase shifters; and

AC coupling structures configured for AC-coupling each of the cathode electrodes to one of the first and second transmission lines, wherein each of the anode electrodes is either DC-coupled or AC coupled to one of the first and second transmission lines.

### BRIEF DESCRIPTION OF THE DRAWINGS

Embodiments disclosed herein will be described in greater detail with reference to the accompanying drawings which represent preferred embodiments thereof, in which like elements are indicated with like reference numerals, and wherein:

FIG. 1 is a schematic block diagram of a conventional travelling-wave waveguide Mach-Zehnder modulator with a dual-differential modulation, in which each of the waveguides arms is differentially modulated using a separate pair of single-ended electrical transmission lines (TLs);

FIG. 2A is a schematic diagram of an optical dual differential modulator (DDM) in accordance with an exemplary embodiment of the present disclosure in which phase shifters in both waveguides arms are differentially modulated using a same pair of single-ended electrical transmission lines (TLs);

FIG. 2B is a schematic diagram of an optical single ended modulator (SEM) in accordance with an exemplary embodiment of the present disclosure in which phase shifters in both waveguides arms are modulated using a same single-ended electrical transmission line (TLs);

FIG. 3 is a schematic expanded view of a phase shifter in the form of a p/n junction;

FIG. 4 illustrates a modified telegrapher's transmission line model with the additional phase shifters loading the transmission lines;

FIG. 5 is a schematic diagram of another exemplary embodiment of the modulator of the present disclosure;

FIG. 6 is a schematic diagram of another exemplary embodiment of the modulator of the present disclosure;

FIG. 7 is a schematic diagram of an exemplary embodiment of a inductor of the present disclosure;

FIG. 8 is a schematic diagram of another exemplary embodiment of a inductor of the present disclosure;

FIG. 9 is a schematic diagram of another exemplary embodiment of a inductor of the present disclosure;

FIGS. 10A to 10D are schematic diagrams of other exemplary embodiment of a inductor of the present disclosure;

FIG. 11 is a schematic diagram of another exemplary embodiment of the modulator of the present disclosure with series phase shifter sections;

FIG. 12 is a schematic diagram of another exemplary embodiment of the modulator of the present disclosure with waveguide delay lines and series phase shifter sections;

FIG. 13 is a schematic diagram of another exemplary embodiment of the modulator of the present disclosure with waveguide delay lines; and

FIG. 13 is a schematic diagram of another exemplary embodiment of the modulator of the present disclosure with transmission lines coupled to the ground plane with capacitors.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the example embodiments. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Furthermore, the following abbreviations and acronyms may be used in the present document:
CMOS Complementary Metal-Oxide-Semiconductor
BiCMOS Bipolar CMOS
GaAs Gallium Arsenide
InP Indium Phosphide
LiNbO3 Lithium Niobate
PIC Photonic Integrated Circuits
SOI Silicon on Insulator
SiP Silicon Photonics
PSK Phase Shift Keying
BPSK Binary Phase Shift Keying
QAM Quadrature Amplitude Modulation
QPSK Quaternary Phase Shift Keying
RF Radio Frequency
DC Direct Current
AC Alternate Current
OSNR Optical Signal to Noise Ratio
MiM Metal-Insulator-Metal
RMS Root Mean Square

Note that as used herein, the terms “first”, “second” and so forth are not intended to imply sequential ordering, but rather are intended to distinguish one element from another, unless explicitly stated. Similarly, sequential ordering of method steps does not imply a sequential order of their execution, unless explicitly stated. The word ‘using’, when used in a description of a method or process performed by an optical device such as a polarizer or a waveguide, is to be understood as referring to an action performed by the optical device itself or by a component thereof rather than by an external agent. Radio frequency (RF) may refer to any frequency in the range from kilohertz (kHz) to hundreds of gigahertz (GHz). The term p/n junction encompasses p/i/n junctions having a region of substantially intrinsic conductivity located between the p-doped and n-doped regions. The term “differential signal” refers to a signal composed of two single-ended signals having complementary AC components. The term “inverted differential signal” refers to a differential signal having AC components of its constituent single-ended signals inverted relative to those of a reference differential signal, or a differential signal having high-low and low-high transitions switched. The term “transmission line” (TL) may be used herein to refer to a signal electrode of a transmission line, with the understanding that at least one ground electrode may also present. The term “single-ended transmission line”, or “single-ended TL”, refers to a TL that includes a single signal electrode along which a single-ended RF signal may propagate. The term “differential transmission line”, or “differential TL”, refers to a TL that includes a pair of signal electrodes along which two complementary single-ended RF signals may propagate. The term “electrically connected” is used herein to mean a DC electrical connection with a conducting pathway, unless explicitly stated otherwise. The term “AC coupled” is used herein to mean an electromagnetic, such as capacitive and/or inductive, coupling between two or more elements in the absence of a DC electrical connection between the elements, unless explicitly stated otherwise. The term “electrically coupled” encompasses both DC and AC electrical coupling.

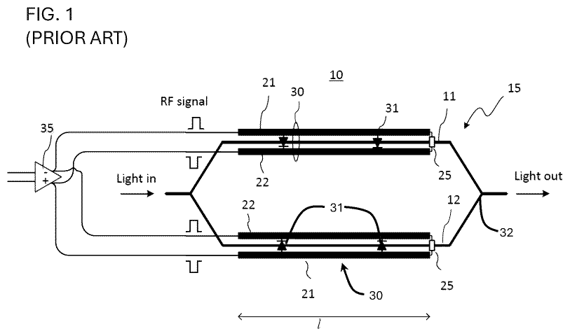

The present disclosure relates to an electro-optic modulator (EOM) and a related method in which two optical waveguides, also referred to herein as the waveguide arms, are used to guide input light from an input optical port to an output optical port along two or more optical paths; such EOMs may also be referred to herein as an optical waveguide modulator or as an optical modulator. One aspect of the present disclosure relates to a dual-differential EOM, which is also referred to herein as the dual-differential modulator (DDM), wherein each of the two waveguide arms is differentially modulated, i.e. modulated by a differential RF signal, and wherein the modulating differential signal is provided to each of the waveguide arms from the same two transmission lines (TLs); thus both waveguide arms may be modulated using the same differential amplifier that drives a single TL pair, which reduces the power requirements on the differential driver up to a factor of two compared to the Dual Differential MZM 10 of FIG. 1 in which each waveguide arm is driven by a dedicated TL pair.

Another issue of practical importance that is related to the driver's maximum voltage swing is the power consumption, which reduction is typically desired. The part of the RF power P_{diss} dissipated in the MZM that depends on the voltage swing at the driver's output is inversely proportional to the characteristic impedance Z_{MOD} of the modulator, P_{diss}=V_{RMS_SWING}²/Z_{MOD}, where V_{RMS_SWING} is the RMS value of the peak-to-peak voltage swing V_{PP} at the output of the driver, for example for a sinusoidal signal V_{RMS_SWING}=V_{PP}/(2√2). Thus, increasing the modulator impedance Z_{MOD} allows to reduce its power consumption, and ultimately the cost of manufacturing and operating the optical transmitter. Furthermore, replacing two TL pairs with one allows to reduce the modulator foot print and thus the chip area of the modulator. Furthermore the increase in modulator impedance may be used in a tradeoff with other design parameters of the modulator, for example by “trading” the increase in the impedance for a higher bandwidth.

For the Dual Differential MZM 10, the modulator impedance Z_{MOD} is the load impedance Z_{DDM} of the differential driver 35, which is defined by the impedance of the two TL pairs 30 connected in parallel, i.e. Z_{DDM}=Z/2. Here Z=sqrt(L_{TL}/(C_{TL}+C_{PH})) is the impedance of each TL pair 30, with L_{TL} and C_{TL} denoting the inductance and capacitance of one TL pair 30, respectively, and C_{PH} is the total capacitance of the phase shifter in one waveguide arm.

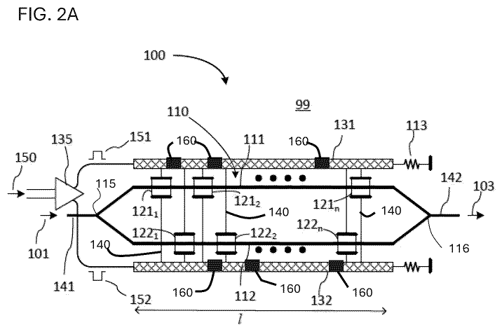

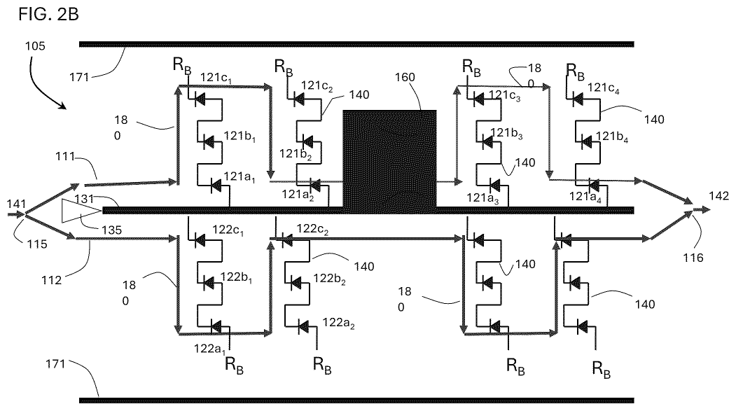

With reference to FIGS. 2A and 2B, an optical Mach-Zehnder modulator, e.g. a dual differential modulator (DDM) 100, FIG. 2A, or single ended modulator (SEM) 105, FIG. 2B, in accordance with example embodiments of the present disclosure, in which a plurality of first phase shifters 121₁ to 121ₙ are disposed in a first optical waveguide arm 111, and/or a plurality of second phase shifters 122₁ to 122ₙ are disposed in a second optical waveguide arm 112 of a Mach-Zehnder interferometer (MZI) 110. The phase shifters 121₁ to 121ₙ and/or the second phase shifters 122₁ to 122ₙ, are differentially driven by a first RF electrical signal 151 or by complementary first and second RF electrical signals 151 and 152, respectively from the same first and/or second single-ended transmission lines (TLs) 131, 132 that extend along the first and second optical waveguide arms 111 and 112. The first and/or second RF electrical signals 151 and 152 are fed at their input ends from a RF driver 135. When each of the first and second optical waveguide arms 111 and 112 of the MZI 110 is differentially modulated, the peak-to-peak voltage swing V_{PP} that the differential RF driver 135 needs to generate is one half of that of an equivalent SEM. Furthermore since the differential RF driver 135 has to drive only a single pair of first and second TLs 131, 132, its load impedance may be substantially equal to the load impedance of an equivalent SEM and is twice the load impedance of the DDM of FIG. 1, thereby advantageously reducing the power requirements on the differential RF driver 135.

Continuing to refer to FIGS. 2A and 2B, in the illustrated embodiment DDM 100 and SEM 105 includes an input optical port 141 for receiving an input optical signal 101, an output optical port 142 for outputting modulated light 103, and the first and second optical waveguide arms 111 and 112 extending optically in parallel between the input and output optical ports 141, 142 to guide sub-beams of the input optical signal 101 from the input optical port 141 to the output optical port 142 for outputting a modulated output optical signal along two light paths. An optical splitter 115 disposed at one end of the first and second optical waveguide arms 111 and 112 is configured for splitting the input optical signal 101 into two, e.g. equal, sub-beams, and an optical combiner 116 disposed at the opposite end of the first and second optical waveguide arms 111 and 112 is configured for combining the two sub-beams together. The first waveguide arm 111 includes one or more first phase shifters 121₁, 121₂, . . . 121ₙ that may be referred generally as the first phase shifters 121, while the second waveguide arm 112 includes one or more second phase shifters 122₁, 122₂, . . . 122ₙ that may be referred generally as the second phase shifters 122. The number n of the phase shifters in each first and second optical waveguide arm 111 and 112 may vary from 1 to 20 or more, and may be the same for each optical waveguide arm, although it is not a requirement. In example embodiments described hereinbelow each of the first and second phase shifters 121, 122 has two electrodes, which are disposed at opposite sides of the respective first and second optical waveguide arm 111 and 112, and which may be referred to herein as the anode electrode and the cathode electrode, or simply the anode and the cathode. The first and second phase shifters 121, 122 are configured to vary the refractive index in at least a portion of the respective first and second optical waveguide arm 111 and 112 in dependence to a sign and magnitude of a voltage applied between the anode and the cathodes electrodes, thereby modulating the optical phase of light propagating therethrough. In some embodiments the phase shifters 121, 122 may be configured so that their phase modulation efficiency depends on the location along the first and second optical waveguide arms 111 and 112. Although the first and second phase shifters 121, 122 are shown in FIG. 2A with a relative shift therebetween along the length of the DDM 100 for convenience of illustration, in a typical embodiment they may be pair-wise aligned so as to be at a same optical distance from an input optical port 141.

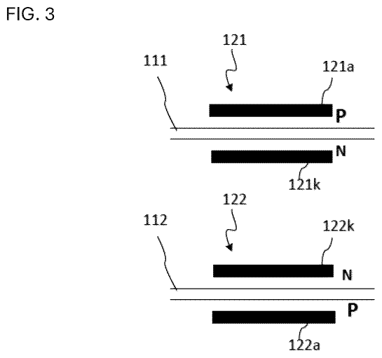

Referring also to FIG. 3, in an example embodiment each of the first and second phase shifters 121 and 122 may be in the form of a p/n junction with an anode electrode 121j or 122j respectively, and a cathode electrode 121k or 122k respectively. In such embodiments the first phase shifters 121 may also be referred to as the first p/n junctions, and the second phase shifter 122 may also be referred to as the second p/n junctions.

In one embodiment, one of the first and second TLs 131 and 132, for example the first TL 131, may be electrically coupled to the anode electrode 121j of each of the first phase shifters 121 and to the cathode electrode 122k of each of the second phase shifters 122, and the other of the first and second TLs, for example the second TL 132, may be electrically coupled to the cathode electrode 121k of each of the first phase shifters 121 and to the anode electrode 121j of each of the second phase shifters 122. With this configuration, when the first and second TLs 131 and 132 are differentially driven with complementary single-ended signals 151, 152, the first and second phase shifters 121 and 122 are modulated in counter-phase, thereby affecting a push-pull modulation of light in the first and second optical waveguide arms 111 and 112.

The first and second TLs 131 and 132 are represented in FIGS. 2A and 2B by their respective signal electrodes but may also include one or more ground electrodes that are not shown in the figure to avoid clutter. They may be generally in the form of any suitable TLs, including but not limited to microstrip TL, coplanar (CPW) TL, conductor backed CPW, and stripline TL. The first and second TLs 131 and 132 may be differentially driven from one end by the differential RF driver 135, and may be terminated at the other ends with a suitable line termination, e.g. termination resistor 113, which may be in the form or include a resistor, having a characteristic impedance Z_{DDM}/2 so as to suppress the reflection of electrical signals at the end of the first and seconds TL 131 and 132. Here Z_{DDM} denotes the load impedance seen by the differential RF driver 135:

$${Z}_{D D M} = \sqrt{\frac{{L}_{T L}}{{C}_{P H} + {C}_{T L}}}$$

where L_{DTL} and C_{DTL} are the inductance and capacitance of the differential TL formed by the first and second TLs 131, 132, and C_{PH} is the total capacitance of all of the first and second phase shifters 121 and 122 in both the first and second optical waveguide arms 111 and 112. The load impedance Z_{DDM} seen by the RF driver 135 is greater than the load impedance seen by the driver 35 of the Dual Differential MZM 10 of FIG. 1. The DDM 100 requires less current, and therefore lower power, to achieve the same modulation efficiency of the input optical signal 101.

In some exemplary embodiments, the first and second optical waveguide arms 111 and 112 of the MZI 110 and the first and second TLs 131, 132 may be disposed over a support substrate or wafer 99 in a semiconductor chip, such as for example a silicon photonics (SiP) chip, GaAs based chip, or InP based chip, or any other chip of a suitable semiconductor material. In one embodiment the MZI 110 and the first and second TLs 131, 132 are formed in or upon a SOI chip, with the first and second optical waveguide arms 111 and 112 forming the MZI 110 having their cores defined in a silicon layer of the SOI chip. In some embodiments the first and second optical phase shifters 121 and 122 may be depletion-type high speed phase modulators (HSPMs) in the form of p/n junctions, for example formed within the Si waveguide cores. In some embodiments the p/n junctions of the first and second optical phase shifters 121, 122 may be in the form of PIN junctions, with an intrinsic (I) region in the middle of the waveguide core sandwiched between a P-doped and an N-doped regions. It will be appreciated that a waveguide MZI with p/n junction based HSPMs in its arms may also be formed in semiconductor materials other than Si, and corresponding embodiments of the DDM 100 are within the scope of the present disclosure.

When embodied as p/n junctions, the phase shifters 121, 122 modulate the refractive index in the first and second optical waveguide arms 111 and 112 by varying the concentration of free charge carriers therein in response to an applied voltage, thereby modulating an optical phase of light propagating therein. For optimal operation the p/n junctions 121 and 122 may be suitably biased, for example reversed biased so as to operate in the depletion mode in which the number of free carriers in the waveguide is relatively small. When reverse biased, the p/n junctions 121 and 122 may be referred to as carrier depletion based HSPMs. Accordingly, in such embodiments the DDM 100 may include electrical circuitry for providing a DC bias voltage to at least one of the cathode and anode electrodes of each p/n junction 121 and 122. In some embodiments it may be configured to provide different DC voltages to the anodes and the cathodes of the p/n junctions 121 and 122 independently on the RF data signals 151, 152 propagating along the first and second TLs 131 and 132. This circuitry may include bias resistors R_{B}, electrical leads 140, and AC coupling circuitry 175 providing AC coupling pathways between the cathodes 121k, 122k of the p/n junctions 121, 122 and the TLs 131, 132 and/or AC coupling pathways between the anodes 121j, 122j of the p/n junctions 121 and 122 and the first and second TLs 131 and 132.

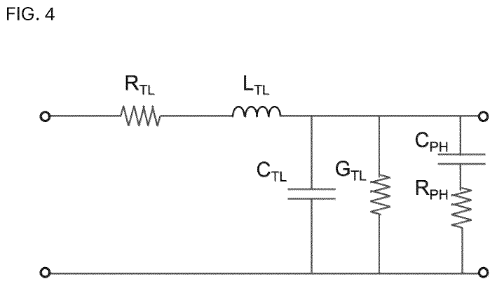

Often, for Mach-Zehnder DDM 100 or SEM 105, a technique utilized to extend the bandwidth of the modulator is to incorporate the transmission lines (TL) 131 and/or 132 connected to the differential RF driver 135 that is uniformly or periodically loaded with phase shifter elements 121 and 122. Since typically a device that does not incorporate a transmission will be limited by either the RC bandwidth of the modulator, for example with 50Ω impedance inputs, or by the inaccuracy of a lumped-element analysis for very long electrodes. By co-designing the optical group delay with the high-speed electrical propagation, the RC limitation of an MZM is replaced with transmission line loss limitations for a traveling wave MZM. The well-known telegrapher's equations modified with an additional R_{PH} C_{PH} loading to represent the phase shifters 121 and 122 is a method for describing this limitation. FIG. 4 illustrates a modified telegrapher's transmission line model with the additional phase shifters 121 and 122 loading the transmission lines 131 and 132. Note that in practice additional circuit elements may be needed to accurately represent the designed geometry at greater than gigahertz electrical frequencies. With the modified phase shifter of the model, the RF transmission line losses show certain dependencies, including a proportionality to approximately R_{PH}C_{PH}². Actual implementations of transmission lines 131 and 132 may have additional parasitics that are not reflected in this equation.

Impedance can be calculated based on the telegrapher's equations as approximately.

$$\sqrt{\frac{{L}_{T L}}{{C}_{T L} + {C}_{P H}}}$$

In the case where dual differential signaling is used, the effective C_{PH} quadruples, and the impedance is halved. In order to increase the impedance to be compatible with common drive electronics, it is necessary to increase the transmission line inductance L_{TL} by a corresponding factor. Typical transmission line TL geometries often cannot be modified by simply changing the cross-sectional dimensions or ground wire to signal wire spacing. An alternative to uniform geometry changes is to place one or more inductors 160 in series within the transmission lines 131 and 132.

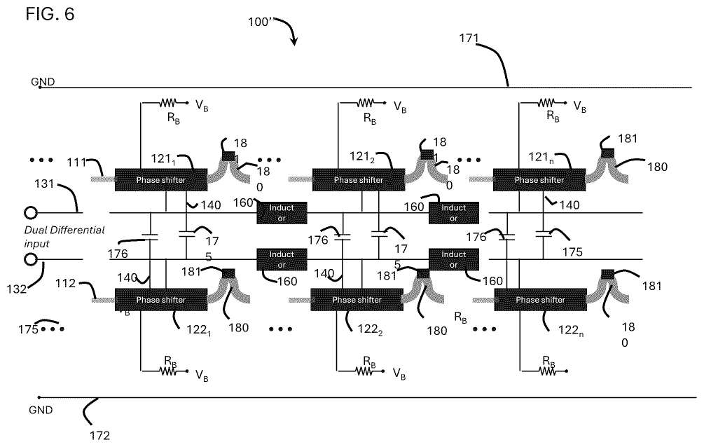

With reference to FIG. 6, inductors 160 placed in series with each of the first and/or second TL 131 and 132 are used to increase the impedance of the SEM 105, the DDM 100′ and the DDM 100″ by increasing the series inductance of each of the first and second TL 131 and 132. In order to maintain velocity matching, i.e. compensate for delays caused by the inductors 160, additional waveguide delay line (WDL) segments 180 may be placed between one or more, preferably each, of the first phase shifters 121 and/or between one or more, preferably each, of the second phase shifters 122. The resistance value of the termination resistor 113 may also be configured, either statically for a desired value or actively for an in-situ adjustment in order to match the new characteristic impedance of each of the first and/or second TL 131 and 132 to provide velocity matching between the RF electrical signals 151, 152 and the sub-beams of the input optical signal 101 to compensate for delays in the RF electrical signals 151 and 152 caused by the inductors 160.

The WDLs segments 180 may include additional optical phase shifters 181 electrically connected to a corresponding one of the first and second TL 131 and 132. If the WDL segments 180 do include additional optical phase shifters 181, then the length of the first and second optical phase shifters 121 and 122 in the first and second optical waveguide arms 111 and 112 may be reduced. The optical phase shifters 121 and 122 and the WDL segments 180 may be arranged in a meandering pattern in order to increase the total optical group delay from the input optical port 141 to the output optical port 142 of each DDM 100.

With the inductors 160 connected in series in the first and/or second TL 131 and 132, the capacitance C_{PH} may also be increased by a similar proportion while maintaining the same characteristic impedance, thereby improving the modulator Vπ efficiency.

The inductors 160 can be placed periodically, i.e. equally spaced apart, with uniform values along the length of the first and/or second TL 131 and 132 in order to create a uniformly higher characteristic impedance.

The inductors 160 may also be placed aperiodically, i.e. irregularly space apart, with nonuniform values along the length of the first and/or second TL 131 and 132 in order to create a uniformly higher characteristic impedance, such that the net average of per-unit-length inductance is constant. Non-uniform placement may dampen resonances caused by uniform periodicity in the first and/or second transmission lines 131 and 132.

The inductors 160 may also be placed periodically with nonuniform values along the length of the first and/or second TL 131 and 132 in order to adjust the characteristic impedance of the transmission line 131 and 132 from one value, e.g. 50Ω differential to another value, e.g. 100Ω differential, i.e. the impedance of the first and/or second transmission lines 131 and 132 will vary with location along the transmission line. In this way, the input impedance of the DDM 100″ may be configured to match the input impedance of a particular electrical circuit electrically coupled thereto, while the termination may enable higher termination resistance values, and therefore possibly lower electrical power dissipations if the termination resistor is connected to a voltage source.

The inductors 160 can be positioned between the electrical leads 140 to adjacent phase shifters 121₁ to 121ₙ in the transmission line 131, and/or between the electrical leads 140 to adjacent phase shifters 122₁ and 122ₙ in the transmission line 132; however, other arrangements and positioning are within the scoped of the invention. The inductors 160 can be placed: 1) uniformly distributed along the length of the first and/or second transmission lines 131 and 132 in order to maintain a uniform transmission line impedance, or 2) placed on non-uniform but monotonically decreasing or increasing frequency in order to monotonically adjust the transmission line characteristic impedance. It may be advantageous to terminate the first and/or second transmission lines 131 and 132 at a higher impedance than the input characteristic impedance to reduce power consumption.

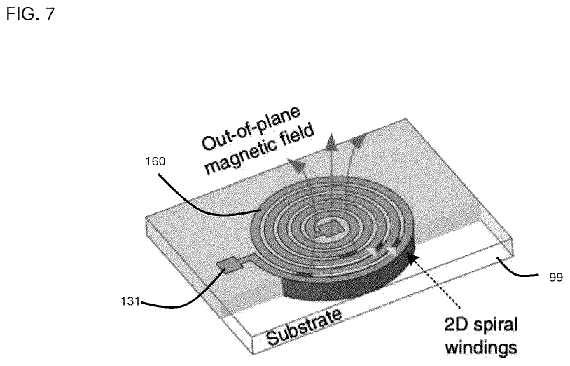

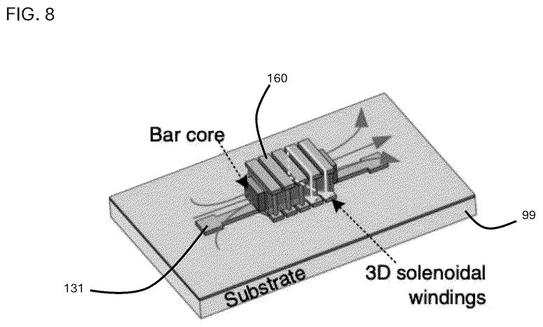

The inductors 160 can have equal or different values, e.g. a 50 pH to 5000 pH, preferably 100 pH to 500 pH. The inductors 160 may be configured with a static inductance value or an active inductance value configured for adjusting the inductance value thereof during installation or use. The inductors 160 can take the form of a conductive wire wound in a coil, or a spiral with magnetic field out-of-plane, as in FIG. 7 or a spiral with a magnetic field in-plane, shown in FIG. 8, as disclosed in https://www.nature.com/articles/s41378-021-00275-w.pdf, which is incorporated herein by reference.

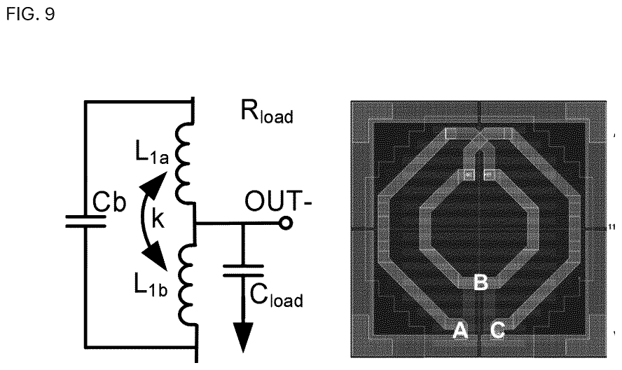

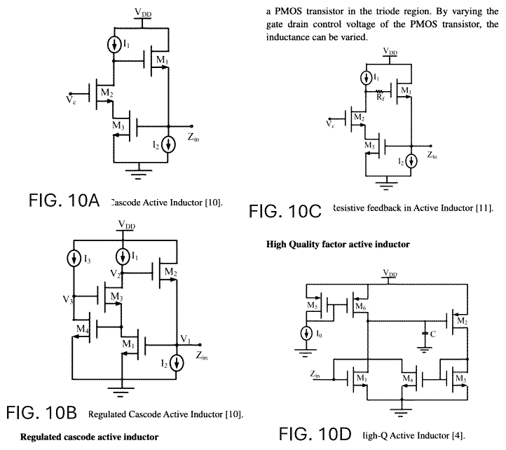

Other possible inductors 160 include a T-coil, illustrated in FIG. 9, and disclosed in https://pure.tue.nl/ws/portalfiles/portal/3201183/Metis220846.pdf, which is incorporated herein by reference. Active inductor with many different possible circuit architectures, including a Cascode Active inductor, illustrated in FIG. 10A, a Regulated Cascode active inductor illustrated in FIG. 10B, a resistive feedback active inductor in FIG. 10C, and a High-Q Active inductor illustrated in FIG. 120, and disclosed in https://www.researchgate.net/profile/Shruti-Oza-4/publication/362909404_CMOS_Active_Inductor_A_Technical_Review/links/6307181c1ddd4 4702108b92f/CMOS-Active-Inductor-A-Technical-Review.pdf, which is incorporated herein by reference.

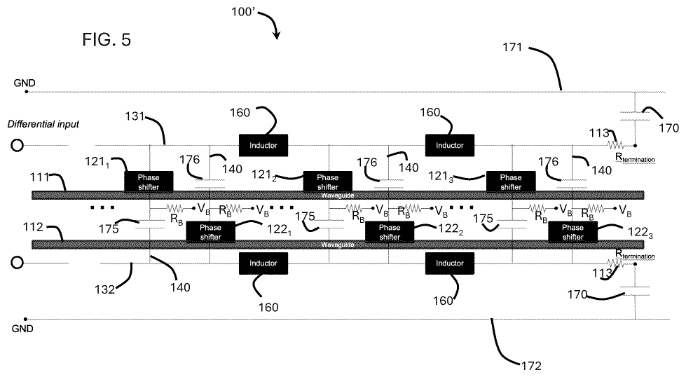

With reference to FIG. 5, in some exemplary embodiments, an open-drain or open-collector transistor architecture is used to drive the traveling-wave, Mach-Zehnder DDM 100′. In such an architecture, the bias voltage e.g. the complementary first and second RF electrical signals 151, 152, is applied through a termination resistor 113, Rₜₑᵣₘᵢₙₐₜᵢₒₙ with voltage Vₜₑᵣₘᵢₙₐₜᵢₒₙ. In order to decouple any noise from the voltage Vₜₑᵣₘᵢₙₐₜᵢₒₙ, in particular, parasitics arising from nonidealities in the resistance R, e.g. series inductances can cause noise coupling into the signal path, decoupling capacitors 170 are provided to ground planes 171 and 172 corresponding to the transmission lines 131 and 132.

With further reference to FIGS. 5 and 6, to enhance the Vπ of the DDM 100′ and DDM 100″ each of the optical phase shifters 121 and 122 are AC-coupled to the other transmission lines 131 and 132, i.e. the phase shifters 121 are AC-coupled to the second TL 132, e.g. with AC coupling circuitry 175, e.g. a capacitor, and the phase shifters 122 are AC coupled to the first TL 131 with a capacitor 176. In doing so, the differential voltage swing applied across the electrodes, i.e. the first and second TL's 131 and 132, increases the change in voltage across the first and second phase shifters 121 and 122. The first and second phase shifters 121 and 122 can be one of many different possible devices including, but not limited to, Pockels effect modulators in lithium niobate, barium titanate, organic polymers, or perovskites; carrier injection, depletion, or accumulation in PN junctions; or based on the Franz-Keldysh effect in III-V devices such as indium phosphide.

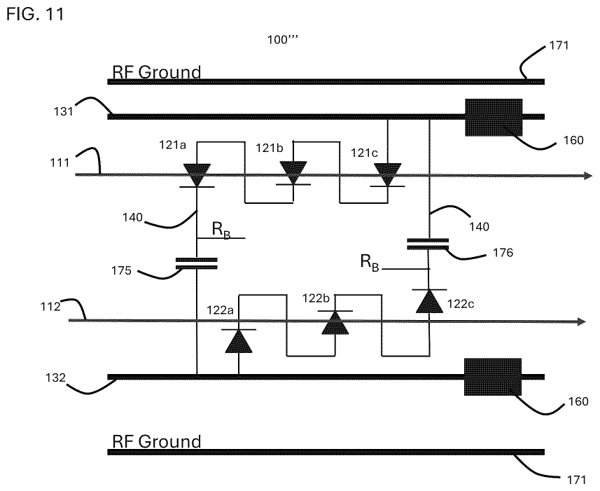

With reference to FIG. 2B and FIG. 11, RF loss decreases as the inverse square of the capacitance of the first and second TL 131 and 132, but the Vπ of the SEM 105 and DDM 100″ is linearly dependent on the capacitance, so it can be advantageous to configure each of the first and second phase shifters 121 and 122 as a series of smaller sections, e.g. 121a, 121b and 121c or 122a, 122b and 122c along the first waveguide arm 111 and/or the second waveguide arm 112, respectively, whereby each of the series of smaller sections is connected to the same lead 140 extending from the first TL 131 and/or the second TL 132, to reduce the capacitive loading on the first and/or second transmission lines 131 and 132. Accordingly, each first and second phase shifters 121 and 122 is electrically connected to the first TL 131 and/or the second TL 132 with a meandering electrical lead 140, i.e. the meandering electrical lead 140 extends both parallel and perpendicular to the corresponding straight and parallel first or second waveguide arms 131 or 132, e.g. in a winding or s-shaped path. Each series of the first and second phase shifters, e.g. 121a, 121b and 121c or 122a, 122b and 122c, if short enough, may be treated as lumped elements. Accordingly, the first and/or second phase shifters 121 and 122 are also configured in order to maintain velocity matching between the optical signals and the electrical signals to compensate for delays in the RF electrical signals caused by the inductors 160.

The series phase shifters, e.g. 121a, 121b and 121c and/or 122a, 122b and 122c, in the SEM 105 and DDM 100′″ reduce capacitance per unit length that is loading the transmission lines 131 and 132, but reduces the voltage applied to a given phase shifter e.g. 121a, 121b and 121c and/or 122a, 122b and 122c, by the same amount. Oftentimes, for traveling wave modulators, the bandwidth of the modulator is limited by RF losses along the transmission lines, e.g. RF losses are roughly proportional to RC², and so reducing the capacitance by a factor enables a longer modulator by a similar factor or almost a similar factor, since there are other bandwidth constraints, such as the skin effect, RC time constant of the phase shifter itself, and other parasitic capacitances and resistances.

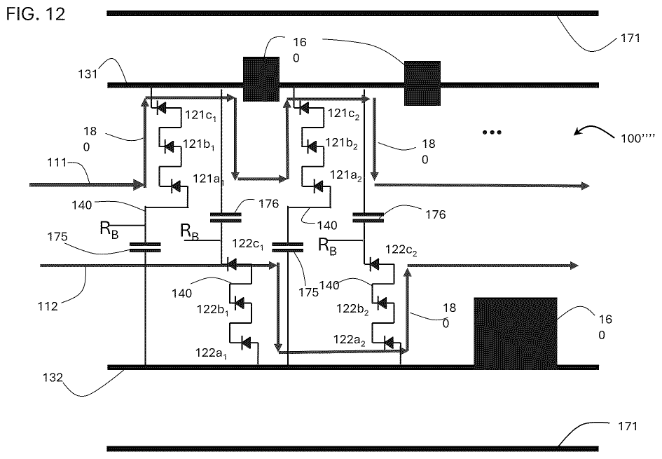

With reference to FIG. 2A and FIG. 12, the SEM 105 and a DDM 100″″ includes the WDL segments 180 and the first and/or second phase shifters 121a, 121b and 121c (and/or 122a, 122b and 122c) in series providing a meandering first and second optical waveguide arms 111 and 112 forming the WDL segment 180, along with a meandering electrical lead 140. By combining the WDL segments 180 with, or as, the meandering waveguide arms 111 and 112, while at the same time connecting the phase shifter sections e.g. 121a, 121b and 121c and/or 122a, 122b and 122c, in series, provides the advantages and flexibility of both to adjust the optical and electrical signal velocity. The WDL segments 180 and/or the first or second optical waveguide arm 111 and 112 can be configured to include a first portion that extends along one of the series of optical phase shifters, e.g. 121a1, 121b1 and 121c1 or 122a1, 122b1 and 122c1, perpendicular to the first and/or second |TL 131 and/or 132, a second portion that extends parallel to the first and/or second TL 131 and/or 132, and a third portion that extends perpendicular to the first and/or second TL 131 and/or 132. The third portion can extend back along the same series of phase shifters, e.g. 121a₁, 121b₁ and 121c₁ or 122a₁, 122b₁ and 122c₁, e.g. one WDL segment 180 per series of phase shifters 121 or 122 (as seen in the first optical waveguide arm 111 in FIGS. 2A and 12) or along a different, subsequent series of phase shifters, e.g. 121a2, 121b2 and 121c2 or 122a2, 122b2 and 122c2, e.g. one WDL 180 per two series of phase shifters 121 or 122 (as seen in the second optical waveguide arm 112 in FIG. 12).

Exactly how to orient the WDL segments 180, the meandering electrical leads 140 and the series of phase shifters, e.g. 121a2, 121b2 and 121c2 or 122a2, 122b2 and 122c2, is a trade-off of: how much optical and/or electrical delay need, the capacitance of the first and second phase shifters 121 and 122, the target impedance, and the efficiency of the first and second phase shifters 121 and 122. More phase shifter sections, e.g. 121a2, 121b2 and 121c2 or 122a2, 122b2 and 122c2, placed in series results in a lower capacitance, but lower voltage across a given first and/or second phase shifter 121 and/or 122. A lower capacitance results in a higher impedance in the transmission line 131 and 132, faster RF signal propagation along the transmission line 131 and 132 (sqrt (LC)), and importantly lower transmission line loss which enables a longer modulator to counteract the voltage division. Adding one or more series inductors 160 will slow the RF wave propagation, which requires more delay/meandered phase shifters, e.g. 121a1, 121b1 and 121c1 or 122a1, 122b1 and 122c1, which may then increase the total capacitance.

The propagation index of the first and second transmission lines 131 and 132 is approximately proportional to: n_{DDM}=\sqrt{L_{TL}(C_{PH}+C_{TL})}. Therefore, an increase in inductance L_{TL} will require a corresponding increase in the length of the WDL segments 180, such that each section of phase shifters 121 and 122 has the same optical group delay and electrical group delay. Optical dispersion in the first and second optical waveguide arms 111 and 112 and electrical dispersion in the first and second transmission line 131 and 132 and the inductors 160 will result in the optical and electrical group delays varying versus frequency. Therefore, a target electrical and optical frequency at which the optical and electrical group delays should be matched is chosen, typically at or near the highest expected operating frequency of the DDM 100.

The WDL segments 180 may be oriented in part or substantially perpendicular to the direction of propagation of the first and second transmission lines 131 and 132 such that the total optical group delay (averaged over a given length) of the sum of the group delays of the first optical phase shifters 121 and 181 (if provided) or 121a, 121b and 121c, in the first optical waveguide arm 111, the group delay of the first optical waveguide arm 111, and the group delay of the optical delay lines 180 is equal to the group delay of the first electrical transmission line 131 (averaged over the same given length) and the group delay of the inductors 160 in the first electrical transmission line 131.

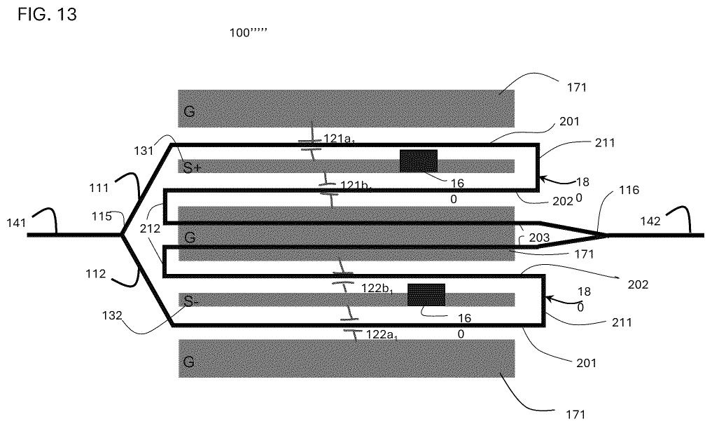

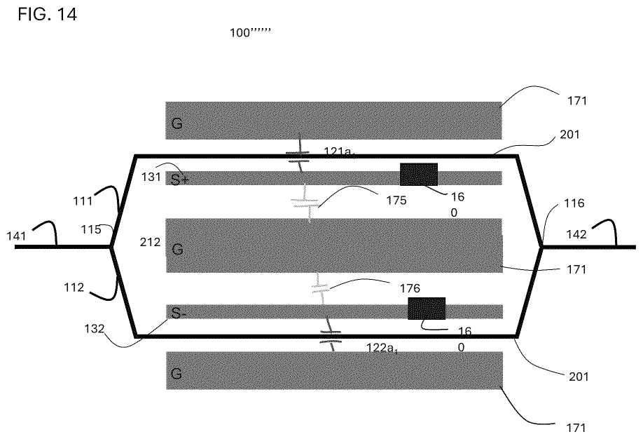

With reference to FIG. 13, in a DDM 100″″″, the WDL segments 180 and/or the first and second optical waveguide arms 111 and 112 with the first plurality of phase shifters 121a₁, 121b₁, and the second plurality of phase shifters 122a₁, 12b₁, respectively, may also meander along a length of first and second straight transmission lines 131 and 132. For example, each of the first and second optical waveguide arms 111 and 112 may include a first elongated section 201 extending from the optical splitter 115 along one side of, e.g. parallel to, the first (or second) transmission line 131, a first curved section 211 extending generally perpendicular to the first elongated section 201 and the first transmission line 131, a second elongated section 202 extending along another side of, e.g. parallel to, the first (or second) transmission line 131 (or 132), a second curved section 212 extending generally perpendicular to the first and second elongated sections 201 and 202 and the first transmission line 131 from the second elongated section 202, and a third elongated section 203 extending from the second curved section 212 to the optical combiner 116. A plurality of elongated sections, e.g. 201 to 20n, may be provided along with a plurality of curved sections 211 to 21n to adjust, e.g. increase, the optical path length of the first (or second) optical waveguide arm 111 (or 112) to delay the optical signal. The first phase shifter sections 121a₁ and 121b₁ and the second phase shifter sections 121a₁, 121b₁ may be disposed in different elongated sections 201, 202 and 203, and connected in parallel, resulting in a higher capacitance along the transmission lines 131 and 132. If the first and second phase shifters 121 and 122 are comprised of Pockels effect modulators, the phase shifter efficiency per length of the first and second transmission lines 131 and 132 is increased in proportion to the additional length of phase shifters added to the modulator. This will result in a shorter total device length that would be required to achieve a target Vπ value for the DDM 100″″″ compared to a modulator without the additional phase shifters sections 121a, 121b, 122a and 122b incorporated in the WDL segments 180.

With reference to FIG. 14, in an optical DDM 100″″″, each of the first and second straight transmission lines 131 and 132 may be connected by a capacitor 175 and 176, respectively, to the metal ground plane 171, with a plurality of the first and second phase shifters 121a₁ etc. and 122a₁ etc. placed along on side of, e.g. parallel to, the first (or second) transmission line 131 (or 132). In the GSGSG (ground, signal, ground, signal, ground) example illustrated, the capacitors 175 and 176 connect the first and second transmission lines 131 and 132, respectively, to the center ground electrode. The capacitors 175 and 176 may be of the MiM (metal-insulator-metal) type or may be formed by a PN junction. The addition of the capacitors 175 and 176, will result in the first and second transmission lines 131 and 132 having lower impedance and higher group delay, which may enable better velocity matching in the RF signal propagation along the first and second transmission lines 131 and 132 and the optical signal propagation along the first and second phase shifters 121 and 122.

Turning to FIG. 5, in this embodiment the cathodes of the first and second phase shifters, e.g. p/n junctions, 121 and 122, may be DC coupled to the signal electrodes of the first and second TLs 131 and 132, respectively, while the anodes of all the first and second phase shifters 121 and 122, e.g. p/n junctions, may be AC-coupled to the corresponding first and second TLs 131 and 132, by AC coupling circuitry 175 and 176 as indicated by capacitors representing the effective capacitance of the corresponding AC coupling structures. The anode bias voltage V_{B} is supplied to the anodes of the first and second phase shifters, e.g. p/n junctions, 121, 122, via the dedicated bias resistors R_{B}, while the cathode bias voltage Vₜₑᵣₘᵢₙₐₜᵢₒₙ is supplied to the cathodes of the first and second phase shifters 121 and 122, e.g. p/n junctions, via termination resistors 113 Rₜₑᵣₘᵢₙₐₜᵢₒₙ and the signal electrodes of the TLs 131, 132. Alternatively, the polarity of each of the first and second phase shifters, e.g. p/n junctions, 121 and 122 can be reversed, so that the anodes of the first and second phase shifters, e.g. p/n junctions, 121 and 122 are DC coupled to the signal electrodes of the first and second TLs 131 and 132 to receive the anode bias voltage Vₜₑᵣₘᵢₙₐₜᵢₒₙ that is provided to the TLs 131 and 132 via the termination resistor Rₜₑᵣₘᵢₙₐₜᵢₒₙ 113. The cathodes of all the first and second phase shifters, e.g. p/n junctions, 121 and 122 in this embodiment are AC-coupled to the signal electrodes of the corresponding first and second TLs 131 and 132, and receive the cathode bias voltage V_{B} via the dedicated bias resistors R_{B}. It will be appreciated that in other embodiment both the cathode electrodes and the anode electrodes of each, or at least some, of the first and second phase shifters 121 and 122, e.g. p/n junctions, may be AC coupled to the signal electrodes of the first and second TLs 131, 132. The bias resistors R_{B} may be configured to provide the desired TL termination resistor 113 as illustrated in FIG. 2A. The bias resistors R_{B} defines the low-cutoff frequency f_{c}=1/(2πR_{H}C_{AC}). Each of the resistors R_{B} and Rₜₑᵣₘᵢₙₐₜᵢₒₙ may be for example in the range of tens of ohms and kiloohms to megaohms. The effective capacitance C_{AC} of the TL-anode/cathode AC coupling circuitry 175, represented by the capacitors, may be for example in the range of tens of femtofarads to units of picofarads.

The above-described exemplary embodiments are intended to be illustrative in all respects, rather than restrictive, of the present invention. Indeed, various other embodiments and modifications to the present disclosure, in addition to those described herein, will be apparent to those of ordinary skill in the art from the foregoing description and accompanying drawings.

For example, it will be appreciated that different electro-optic dielectric materials and semiconductor materials other than silicon, including but not limited to compound semiconductor materials of groups commonly referred to as A3B5 and A2B4, such as GaAs, InP, and their alloys and compounds, as well as such electrooptical materials as lithium niobate (LiNbO3) and the like, may be used to fabricate the optical modulator circuits example embodiments of which are described hereinabove. In addition, phase modulators other than p/n junctions can be used in semiconductor waveguides, including silicon waveguides, such as for example capacitive devices, silicon-insulator-silicon modulating structures, etc. In some embodiments wherein DC biasing of the first and second phase shifters 121 and 122 is not required, the first and second phase shifters 121 and 122 in each optical waveguide arm 111 and 112 may be DC coupled to the first and second TLs 131 and 132. In other embodiments, the phase shifters 121 and 122 in each optical waveguide arm 111 and 112 may be AC coupled to each TL 131 and 132. In another example, although in the example embodiments described hereinabove the cathode and the anode electrodes of the phase shifters 121 and 122 were DC biased using resistors, such as resistors R_{B} in FIGS. 5 and 6, in other embodiments some or all of those resistors may be omitted and the DC bias voltage supplied using a bias-T. In another example, instead using the same termination resistor 113 for the TL termination and to bias the electrodes that are DC coupled to the corresponding TL 131 and 132, such as for example illustrated in FIG. 2A, different resistors may be used for TL termination and DC biasing. In another example, although example embodiments described hereinabove may have been described primarily with reference to a waveguide modulator device including an MZI, it will be appreciated that principles and device configurations described hereinabove with reference to specific examples may be adopted to other types of optical waveguide modulators.

Furthermore, although some of the embodiment's described hereinabove use HSPMs in the form of depletion-mode p/n junctions formed in semiconductor waveguides, other embodiments may use forward-biased or non-biased p/n junctions, or use electro-optic properties of the waveguide arms material that do not require p/n junctions to modulate the refractive index in a portion of the waveguide arm, and hence to modulate the phase or amplitude of propagating light.

Furthermore in the description above, for purposes of explanation and not limitation, specific details are set forth such as particular architectures, interfaces, techniques, etc. in order to provide a thorough understanding of the present invention. In some instances, detailed descriptions of well-known devices, circuits, and methods are omitted so as not to obscure the description of the present invention with unnecessary detail. Thus, for example, it will be appreciated by those skilled in the art that block diagrams herein can represent conceptual views of illustrative circuitry embodying the principles of the technology. All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure. Furthermore, it will be appreciated that each of the example embodiments described hereinabove may include features described with reference to other example embodiments.

Thus, while the present invention has been particularly shown and described with reference to example embodiments as illustrated in the drawing, it will be understood by one skilled in the art that various changes in detail may be affected therein without departing from the spirit and scope of the invention as defined by the claims.

We claim:

1. An optical modulator comprising:
an input optical port for receiving an input light signal;
an output optical port for outputting a modulated light signal;
a first waveguide arm and a second waveguide arm extending between the input optical port and the output optical port to guide the input light signal from the input optical port to the output optical port;
a first plurality phase shifters in the first waveguide arm;
a second plurality of phase shifters in the second waveguide arm;
a first transmission line (TL) extending along the first waveguide arm configured for transmitting an RF electrical signal to the first plurality of phase shifters and/or the second plurality of phase shifters for modulating the input optical signal and; and
a first inductor in the first transmission line configured for increasing impedance of the optical modulator.

2. The optical modulator according to claim 1, wherein the first inductor comprises a plurality of first inductors spaced along the first transmission line.

3. The optical modulator according to claim 2, wherein the plurality of first inductors are equally spaced along the first transmission line.

4. The optical modulator according to claim 3, wherein the plurality of first inductors each have a same inductance value.

5. The optical modulator according to claim 3, wherein some of the plurality of first inductors have different inductance values.

6. The optical modulator according to claim 3, wherein at least one of the plurality of first inductors is positioned between adjacent electrical leads extending to adjacent ones of the first plurality of phase shifters.

7. The optical modulator according to claim 2, wherein the plurality of first inductors are spaced non-uniformly along the first transmission line, but monotonically decreasing or increasing frequency in order to monotonically adjust a characteristic impedance of the first transmission line.

8. The optical modulator according to claim 7, wherein some of the plurality of first inductors have different inductance values.

9. The optical modulator according to claim 1, wherein each of the plurality of first inductors has a value of a 50 pH to 5000 pH.

10. The optical modulator according to claim 1, wherein each of the plurality of first inductors has a value of a 100 pH to 500 pH.

11. The optical modulator according to claim 1, wherein at least some of the plurality of first inductors comprises an active inductor configured for adjusting an inductance value thereof during installation or use.

12. The optical modulator according to claim 1, wherein the first waveguide arm includes a first optical delay line that extends both in parallel and perpendicular to the first transmission line configured for matching velocity of the input optical signal and the RF electrical signal to compensate for delays caused by the first inductor.

13. The optical modulator according to claim 12, wherein at least one of the first plurality of phase shifters is in the first optical delay line.

14. The optical modulator according to claim 13, wherein the first plurality of phase shifters each comprise a plurality of series-connected phase shifter sections.

15. The optical modulator according to claim 1, wherein the first plurality of phase shifters each comprise a plurality of series-connected phase shifter sections.

16. The optical modulator according to claim 12, wherein the first optical delay line includes a plurality of elongated sections extending parallel to the first transmission line, and a plurality of curved sections extending substantially perpendicular to the first transmission line.

17. The optical modulator according to claim 16, wherein the first plurality of phase shifters each comprise a plurality of parallel-connected phase shifter sections, in different sections of the plurality of elongated sections of the first optical delay line.

18. The optical modulator according to claim 1, further comprising a termination resistor in the first transmission line with a resistance configured for providing velocity matching between the RF electrical signal and the input optical signal to compensate for delays caused by the first inductor.

19. The optical modulator of claim 1,
wherein each of the first plurality of phase shifters comprising a first anode electrode and a first cathode electrode;
wherein each of the second plurality of phase shifters comprising a second anode electrode and a second cathode electrode;
wherein the first transmission line is electrically coupled to the first anode electrode of each of the first plurality of phase shifters, and to the second cathode electrode of each of the second plurality of phase shifters;
wherein the optical modulator further comprises:
a second transmission line (TL), which extends along the second waveguide arm, and is electrically coupled to the first cathode electrode of each of the first plurality of phase shifters and to the second anode electrode of each of the second plurality of phase shifters;
a second inductor in the second transmission line; and
a differential driver configured to feed complementary electrical signals into the first transmission line and the second transmission line.

20. The optical modulator according to claim 19, further comprising:
electrical circuitry configured for providing a DC bias voltage to the first cathode electrodes or the first anode electrodes of each of the first plurality of phase shifters; and
AC coupling structures configured for AC-coupling each of the first cathode electrodes to the first transmission line or the second transmission line, wherein each of the first anode electrodes is either DC-coupled or AC coupled to the first transmission line or the second transmission line.

21. The optical modulator according to claim 19, further comprising a first capacitors and a second capacitor connecting the first transmission line and the second transmission lines 131 to a ground electrode configured for lowering an impedance of the first transmission line and the second transmission line.
